(19) United States
(12) Patent Application Publication
(10) Pub. No.: US 2012/0105599 A1
(43) Pub. Date: May 3, 2012

(54) CAMERA SYSTEM AND IMAGE-SHOOTING METHOD WITH GUIDE FOR TAKING STEREO IMAGES AND METHOD FOR ADJUSTING STEREO IMAGES

(75) Inventors: Chung-Wei Lin, Tainan City (TW); Wen-Chao Chen, Kaohsiung City (TW)

(73) Assignee: INDUSTRIAL TECHNOLOGY RESEARCH INSTITUTE, Hsinchu (TW)

(21) Appl. No.: 12/973,908

(22) Filed: Dec. 21, 2010

(30) Foreign Application Priority Data
Nov. 1, 2010 (TW) 99137492

(51) Int. Cl. H04N 13/02; G06K 9/00

(52) U.S. Cl. 348/50; 382/154; 348/E13.074

(57) ABSTRACT

An image-shooting method with guide for taking stereo images is used in a camera system. The camera system utilizes a same lens to take images. The method includes the following steps. A shooting mode is selected. A guiding information is provided by a display unit. A set of images for a target image field is taken by moving the lens to multiple guiding locations according to the guiding information, in which the set of images is at least two view-angle images with different view angles. The view-angle images are corrected with a stereo visual effect. The set of view-angle images is output, and meanwhile, a corresponding shooting information is output. Then, the view-angle images are adjusted according to the shooting information, so as to achieve a desirable stereo display effect.

### CROSS-REFERENCE TO RELATED APPLICATION

This application claims the priority benefit of Taiwan application serial no. 99137492, filed on Nov. 1, 2010. The entirety of the above-mentioned patent application is hereby incorporated by reference herein and made a part of specification.

### BACKGROUND OF THE INVENTION

1. Technical Field

The disclosure relates to an image-shooting technology for stereo images, in particular, to an image-shooting technology with guide for taking stereo images.

2. Background

A stereo image may be presented in many ways, and a simple one is that left and right eyes respectively receive two images having a parallax of a same object, so as to generate a stereo image effect by the visual perception of human eyes. In other words, the two images are corresponding to results of left and right eyes viewing the same object. Therefore, in order to take two 2D images having a parallax that may generate a stereo image, the same object needs to be shot at different view angles, and if the parallax of the two images is insufficient or excessive, the stereo effect will be reduced, or even cannot be achieved.

With the popularization of hardware playback devices for stereo images, stereo image playback devices have become available to ordinary consumers through ordinary commercial channels; however, there is still a short of corresponding stereo image-shooting devices on the market. Or, the technical requirements are so high that ordinary consumers cannot easily obtain stereo content. Generally, in order to take a stereo image, a special device such as a dual-lens camera or a combination of two cameras must be provided. Thus, a special device must be used in order to take stereo photos, resulting in limitations in use.

Conventionally, the quality of stereo images depends on the imaging quality during shooting and subsequent manual adjustment, and no reference to information provided by the camera is made, which not only causes inconvenience to users, but also leads to degradation of the quality of stereo images. With the development of electron optics and the popularization of digital cameras, a digital camera has sufficient operation processing capabilities to process multiple shooting requirements in time.

### SUMMARY

Accordingly, the disclosure is directed to a camera system and an image-shooting method with guide for taking stereo images and a method for adjusting stereo images, so as to guide a user to conveniently use a digital camera to take 2D images for synthesizing a stereo image.

According to an embodiment, the disclosure provides a camera system with guide for taking stereo images, which includes an imaging unit, an information unit, a processing unit, a guiding unit, and an image storage unit.

The imaging unit is capable of taking a corresponding view-angle image for a target image field at a location. The information unit is used for respectively recording a shooting condition information of shooting the target image field at the location, and the taken view-angle image. The processing unit is used for receiving the shooting condition information and analyzing the shooting condition information to estimate a shooting condition of shooting the target image field by the imaging unit next time, until a predetermined number of the view-angle images are taken. After the view-angle images in the predetermined number are completed, the processing unit performs a stereo image correction process on the view-angle images. The guiding unit is used for converting the shooting condition estimated by the processing unit into a guiding information to guide a user to move the imaging unit to the location. The image storage unit is used for storing the view-angle images after the stereo image correction process.

According to an embodiment, the disclosure provides an image-shooting method with guide for taking stereo images, which is used in a camera system. The camera system utilizes a same lens to take images. The method includes: selecting a shooting mode; providing a guiding information by a display unit; taking a set of images for a target image field by moving the lens to multiple guiding locations according to the guiding information, in which the set of images is at least two view-angle images with different view angles; correcting the at least two view-angle images with a stereo visual effect; and outputting the corrected at least two view-angle images, and meanwhile, outputting a corresponding shooting information.

According to an embodiment, the disclosure further provides a method for adjusting stereo images, which is used in a camera. The method includes: taking a first view-angle image and a second view-angle image; analyzing out a set of feature points from the first view-angle image and the second view-angle image; obtaining a camera information respectively corresponding to the first view-angle image and the second view-angle image; weighting the set of feature points according to the camera information; performing an image rectification procedure by rotating at least one of the first view-angle image and the second view-angle image according to the set of weighted feature points to achieve rectification; performing an image translation step by a proper translation of the first view-angle image and the second view-angle image after rectification according to coordinates of the set of weighted feature points, so as to adjust a parallax effect; and outputting an adjusted first view-angle image and an adjusted second view-angle image.

According to an embodiment, the disclosure further provides a camera system with guide for taking stereo images, which includes: a lens, having a single optical axis; an optical image sensor, for recording at least two view-angle images taken by the lens, at least including a first image and a second image; a guiding unit, for providing a guiding information to guide the lens to move to an expected location according to the first image to take the second image; a memory unit, for recording the first image and the second image obtained by the optical image sensor, and a camera information during shooting; and a processing circuit unit, connected to the lens, the optical image sensor, the guiding unit and the memory unit, in which the processing circuit unit includes an image processing algorithm module, for calculating the guiding information.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic block diagram illustrating a camera system according to an embodiment of the disclosure.

FIG. 1B is a schematic diagram illustrating functional units of a camera system according to an embodiment of the disclosure.

FIG. 2 is a schematic flowchart illustrating an image-shooting method with guide for taking stereo images according to an embodiment of the disclosure.

FIG. 3 is a schematic diagram illustrating a directing and moving mechanism according to an embodiment of the disclosure.

FIG. 4 is a schematic diagram illustrating a distance-based guiding mechanism according to an embodiment of the disclosure.

FIG. 5 is a schematic diagram illustrating detection in a portrait shooting mode according to an embodiment of the disclosure.

FIG. 6 is a schematic flowchart illustrating a method for adjusting stereo images according to an embodiment of the disclosure.

FIG. 7 is a schematic diagram illustrating a feature point capturing mechanism according to an embodiment of the disclosure.

FIG. 8 is a schematic diagram illustrating two original 2D images before rectification according to an embodiment of the disclosure.

FIG. 9 is a schematic diagram illustrating two 2D images after rectification according to an embodiment of the disclosure.

FIG. 10 is a schematic diagram illustrating two 2D images after parallax adjustment according to an embodiment of the disclosure.

### DETAILED DESCRIPTION OF DISCLOSED EMBODIMENTS

The disclosure provides a manner for obtaining high quality stereo images without increasing the burden of photographers. Thus, the functional option of taking stereo images may become one of basic functions of digital cameras. A user is guided in different shooting modes to move a camera for shooting, and with assistance of shooting information that can be provided by the camera, adjustment is completed in a single camera, and a desirable stereo image can be directly output.

The disclosure is described below through some embodiments, but the disclosure is not limited to the embodiments. Further, the embodiments may be properly combined.

A camera system provided by the disclosure is configured with a guiding information for taking stereo images, allowing the user to move to locations to take two images having a sufficient parallax. Then, the images are adjusted according to the taken images and information, so as to obtain a desirably adjusted and output stereo image.

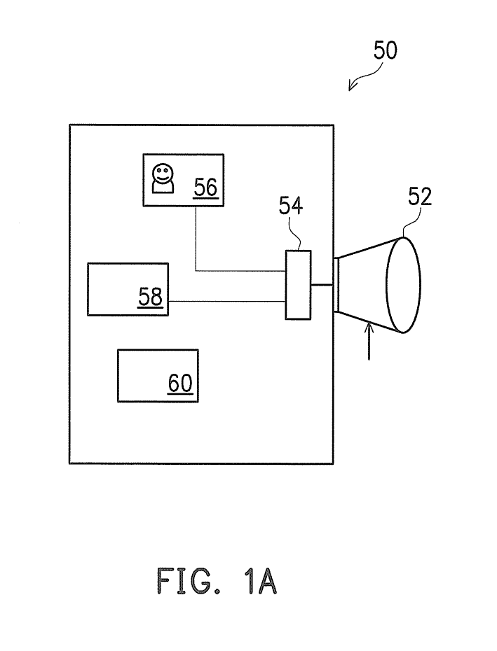

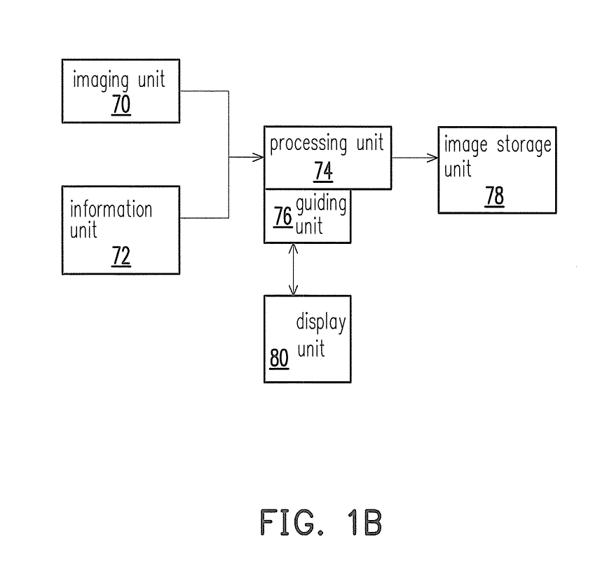

FIG. 1A is a schematic block diagram illustrating a camera system according to an embodiment of the disclosure. Referring to FIG. 1A, a camera system with guide for taking stereo images 50 includes a lens 52, an optical image sensor 54, a display unit 56, a memory unit 58 and a processing circuit unit 60. The lens 52 has a single optical axis. In other words, in this embodiment, two images having a parallax may be obtained by using the camera system with the lens having the same optical axis through guiding. The optical image sensor 54 obtains a first image and a second image taken by the lens 52.

The display unit 56 displays the first image and the second image, and after the first image is taken, displays a guiding information to guide the lens 52 to move to an expected location to take the second image. The memory unit 58 records the first image and the second image obtained by the optical image sensor 54, and a camera information during shooting.

The processing circuit unit 60 is connected to the memory unit 58. The processing circuit unit 60 may include an image processing algorithm module, for performing image feature capturing and shooting guiding. The guiding operation includes receiving respective image data of the first image and the second image and the camera information from the memory unit 58. A feature point group is determined through image processing by using the image data and the camera information. The feature point group is used for calculating a correction parameter to adjust at least one of the first image and the second image, so as to synthesize a stereo image. In another embodiment, the processing circuit unit 60 may be connected to the lens 52, to provide the guiding information to guide the lens 52 to move. In another embodiment, the processing circuit unit 60 may be connected to the display unit 56, to provide the guiding information to the display unit 56, so as to display the guiding information to guide the user to move the lens 52.

The function of guiding the user to take stereo images may maintain image shooting conforming to stereo images when taking stereo images, so as to reduce the probability of an error during subsequent stereo image processing.

The above architecture may also be illustrated in the form of functional units. FIG. 1B is a schematic diagram illustrating functional units of a camera system according to an embodiment of the disclosure. Referring to FIG. 1B, a camera system with guide for taking stereo images includes an imaging unit 70, an information unit 72, a processing unit 74, a guiding unit 76 and an image storage unit 78, in which a display unit may be further used to display taken images and guiding information.

The imaging unit 70 is capable of taking a corresponding view-angle image for a target image field at a location. The imaging unit 70 may include a lens 52, an optical image sensor 54 or other elements. The information unit 72 is used for respectively recording a shooting condition information of shooting the target image field at the location, and the taken view-angle image. The information may be, for example, stored in a memory unit 58. The processing unit 74 is coupled to the information unit 72, and is used for receiving the stored shooting condition information and analyzing the shooting condition information to estimate a shooting condition of shooting the target image field by the imaging unit 70 next time. The shooting condition, for example, includes a proper location or distance of movement, so as to generate a sufficient parallax relative to other view-angle images. The number of images to be taken is at least two, and the shooting guiding continues until a predetermined number of the view-angle images are taken.

After the predetermined number of the view-angle images are completed, the processing unit 74 further performs a stereo image correction process on the view-angle images, as will be described hereinafter. The guiding unit 76 is used for converting the shooting condition estimated by the processing unit 74 into a guiding information, so as to enable the imaging unit 70 to move to a next shooting location according to the guiding information to take a next view-angle image. The guiding information is, for example, displayed by a display unit 80, 56. The display unit 80, 56 may also be used for previewing the view-angle images at each processing stage. In another embodiment, the guiding unit 76 may be integrated in the processing unit 74, that is, the processing unit 74 converts the estimated shooting condition into the guiding information.

The image storage unit 78 is used for storing the view-angle images after the stereo image correction process performed by the processing unit 74. The view-angle images may be stored in the image storage unit 78, and a stereo visual image may be formed by using any two of the view-angle images as left-eye and right-eye images. Generally, according to the specification of the camera device, two or more view-angle images may be output, allowing multiple viewers to view the stereo visual image, and allowing the viewers to change viewing positions.

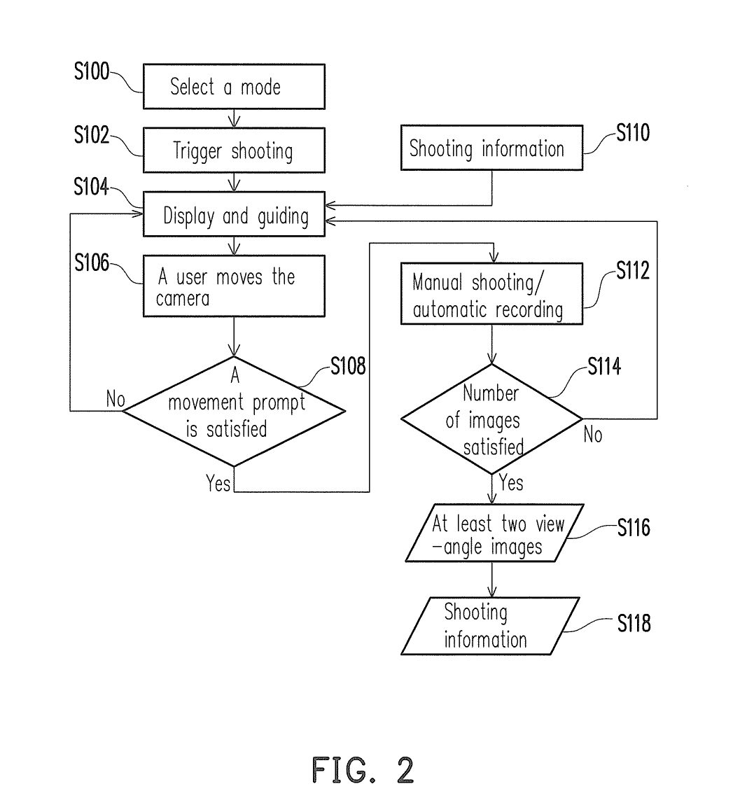

FIG. 2 is a schematic flowchart illustrating an image-shooting method with guide for taking stereo images according to an embodiment of the disclosure. Referring to FIG. 2, the image-shooting method with guide for taking stereo images is a processing manner used in a camera system. The camera system includes a lens having a single optical axis. In Step S100, a shooting mode is selected first. During mode selection, for example, the user selects a shooting mode of taking 3D images, mainly by setting a parameter setting of the camera according to an image field to be shot. For different settings such as portraits, landscapes, and close-ups, coordinate locations of different features in the image are captured.

In Step S102, after the mode is selected, image shooting is triggered. The image shooting may be triggered by different triggering manners according to different camera types, for example, triggered with a touch screen or a button.

In Step S104, display and guiding functions are performed. In order to obtain a stereo visual effect, image features viewed by left and right eyes need to be consistent and have a sufficient parallax. Therefore, any two images do not form a desirable stereo image. For example, when a first image is taken, a guiding information is provided by a display unit. The guiding information is, for example, guiding locations for estimating a required amount of movement. In this embodiment, for example, an image is taken first to serve as a reference for guiding. However, if a continuous shooting mode is selected, it only needs to move a required distance, and subsequently select two images from multiple images with different view angles to serve as left-eye and right-eye images.

Further, in order to correctly estimate the distance of movement and perform a subsequent image correction process, a shooting information of the camera is also provided in Step S110. The shooting information is, for example, information provided by camera hardware, or hardware information that may be provided in the future, and may provide the guiding information for taking stereo images, for example, ranging information (infrared/range finder/digital ranging), relative coordinates of the focus of the lens in the image, or gyro location information.

In Step S106, the user moves the camera to the guiding location according to the guiding information. In Step S108, it is checked whether a movement prompt is satisfied. If not, the process returns to Step S104 to continue moving the camera. If the camera reaches the prompted location, the process proceeds to Step S112 to take an image, and store a shooting information.

In Step S114, if it still needs to continue taking images, the process returns to Step S104 to take images according to the guiding information until a set of images reaching a required image number are taken. Then, in Step S116, data of at least two view-angle images is output from the set of images as required. As long as left and right eyes of any viewer view two view-angle images at a suitable location, a stereo visual image can be foamed. In Step S118, the shooting information corresponding to the view-angle images are output.

After the image shooting is completed through guiding, original left-eye and right-eye images are selected, and then at least one of the left-eye and right-eye images are corrected, for synthesizing a stereo image.

The display and guiding mechanism is described below. In order to guide the user to horizontally move the camera system (for example, a camera), feature points are displayed on a display screen, and guiding in terms of the direction of movement is provided to the user, and after the user satisfies a correct amount of movement, the camera performs data recording. Calculation of the correct amount of movement may be based on the following implementation methods.

FIG. 3 is a schematic diagram illustrating a directing and moving mechanism according to an embodiment of the disclosure. FIG. 3(a) illustrates, for example, the content of a view-angle image used as a reference, and FIG. 3(b) illustrates, for example, another subsequently corrected view-angle image. When the camera focuses, feature points of a near object and a far object projected on the camera are respectively Pnear and Pfar n FIG. 3(a), with a coordinate difference between the two being ΔP. After the user moves, new positions in the frame of FIG. 3(b) are Pnear′ and Pfar′, with a coordinate difference being ΔP′. The movement of the location of the user must satisfy the following equations:

$$\begin{matrix}Δ P = \vert {P}_{near} - {P}_{far} \vert & ( 1 ) \\ Δ {P}^{′} = \vert {P}_{near}^{′} - {P}_{far}^{′} \vert & ( 2 ) \\ \vert Δ P - Δ {P}^{′} \vert \leq 0.03 \times \frac{Display viewing distance}{Display width} \times Resolution of photo taken & ( 3 )\end{matrix}$$

where, |ΔP−ΔP′| represents an amount of parallax that foreground and background images must reach when the camera is moved. When the camera is moved to satisfy the value, that is, satisfy the distance of movement, a second image may be captured. The quotient of display width and viewing distance may be set to as fixed value, for example, 4.0.

If the camera has additional hardware other than that for shooting, for example, a gyro or horizontal detection, information of the hardware may be used to calculate the distance of movement. An amount of movement that the camera should satisfy is calculated according to a target distance obtained by ranging together with information such as a focal length or depth of field of the camera, and the amount of movement together with a displacement of the camera calculated by the gyro provides a reference for the user to determine whether to continue moving the camera.

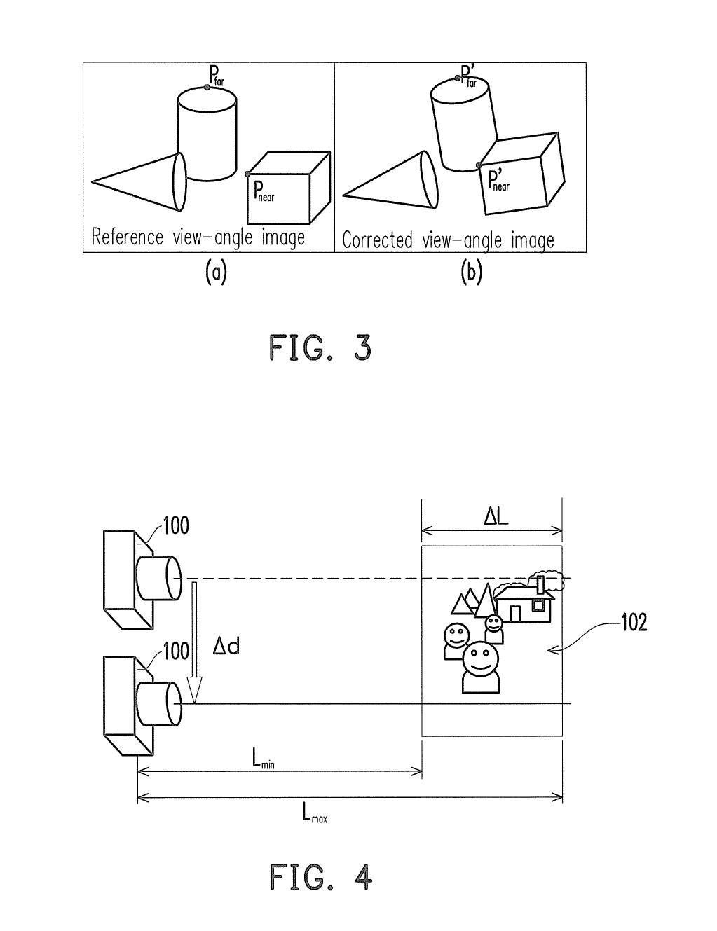

FIG. 4 is a schematic diagram illustrating a distance-based guiding mechanism according to an embodiment of the disclosure. Referring to FIG. 4, since the camera 100 has an externally attached ranging function to detect a depth of field ΔL of a scene 102, so as to determine the distance of movement. The distance of movement Δd may be obtained based on the following equation:

$$Δ d = \frac{k \times ( {L}_{max} \times {L}_{min} ) / ( {L}_{max} - {L}_{min} )}{f} , \qquad ( 4 )$$

where, k is an allowable amount of parallax on a projected image, and may be set to 1.2 mm for 35 mm frames, Lmax and Lmin represent a visible range of the depth of field ΔL, and f is the focal length of the camera.

In other words, the guiding may be achieved in different manners, and is mainly achieved by guiding the lens of the camera to move a proper distance, so as to take images that may form a 3D visual image.

Since the stereo image requires at least two images with different view angles that may cause a parallax, unprocessed image data must be capable of providing images with different view angles. Moreover, a digital camera itself can provide a sufficient amount of information, so as to improve the accuracy of image processing and the quality of stereo processing.

For unprocessed image data, since the system utilizes a lens having a single optical axis, images may be recorded in two formats, namely, photo and video formats. A photo may be determined according to a data format required by the camera, for example *.jpeg, *.raw, or *.tiff, and if a photo is used as unprocessed image data, multiple photos, that is, more than two photos, must be captured. A video mainly records an image sequence, and the data format also depends on a specification processed by the camera, for example *.mpeg4, *.mjpeg, or *.mov, and in subsequent image processing, at least two images are captured from the image sequence for stereo image processing.

Information of the shooting mode may be determined by the user, and in operation, a rotary disc mechanism may be used, or touch selection of a touch screen is used as an alternative. The selection of the shooting mode mainly controls focusing information, feature information, exposure information and the like when capturing images. The information depends on selection of the user, and shooting prompts vary with different shooting modes selected by the user.

In order to meet the requirements of subsequent capturing of stereo image information, the shooting information in the mode selected by the user must be recorded, for example, resolution, bit depth, focal length, exposure time, exposure program, and shooting time. Moreover, information that may possibly be used during stereo adjustment is additionally recorded, for example, hardware parameters that facilitate subsequent automatic stereo adjustment such as face position during face detection, focusing distance of the focused object, and frequency of image taking (fps) of video recording.

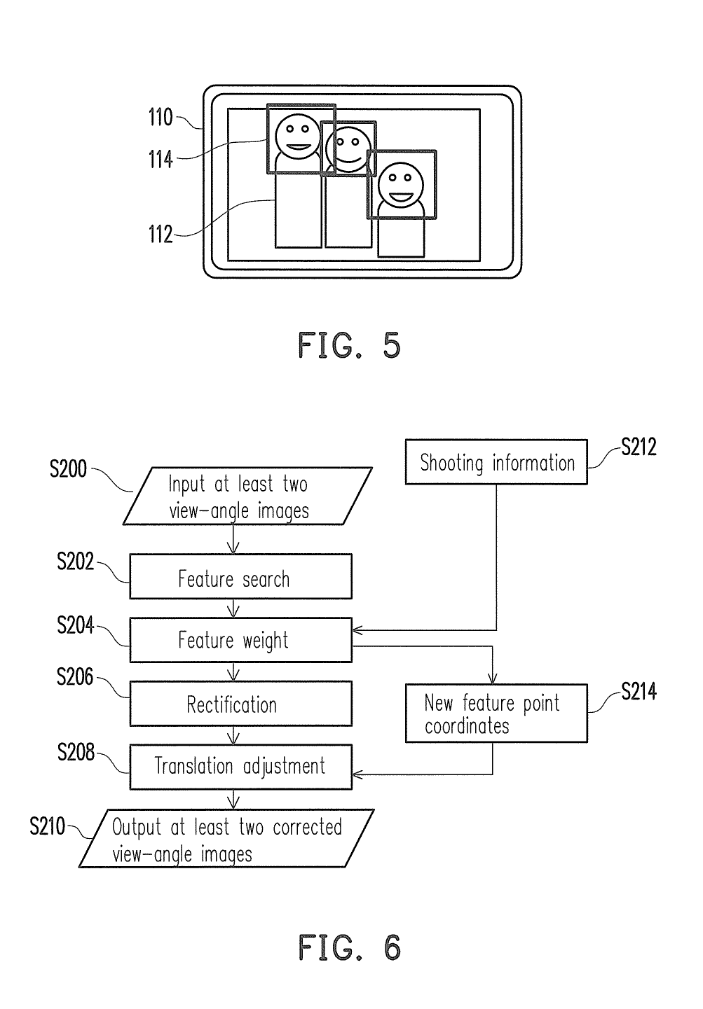

According to different shooting modes selected by the user, the camera performs different shooting guiding, and meanwhile, shooting information (for example, portrait shooting, focal length for face focusing, and coordinate location of face) is maintained, and according to different modes, image features of input images may be recorded. FIG. 5 is a schematic diagram illustrating detection in a portrait shooting mode according to an embodiment of the disclosure. Referring to FIG. 5, when the camera 110 is in a portrait shooting mode, a distance by which the camera should move when taking two images of the same face may be calculated by detecting a coordinate location of a face 114 of a person 112 provided by the shooting information of the camera 110. Preferable unprocessed images may be captured with the distance. In addition, for purpose of subsequent stereo adjustment and output, coordinate locations of human face features are captured, and meanwhile, recorded in the shooting information for subsequent adjustment and output.

For another example, in a distant landscape shooting mode, a distant object requires a large amount of movement in order to achieve a stereo effect. However, a large amount of movement leads to a large parallax of near views, causing discomfort. Therefore, during shooting, according to the proportion of far views in frame distribution, locations of feature points are recorded in the shooting information for subsequent adjustment and output.

In addition, the depth of field for close-up objects is small during shooting, a sufficient stereo parallax may be achieved through a small amount of movement, but the stereo effect may be reduced due to an excessive parallax resulting from an excessive amount of movement by the user. Therefore, according to the amount of movement for near-view features, locations of feature points are recorded in the shooting information for subsequent adjustment and output.

Subsequent image correction is described below. Since the movement of the camera by the user may lead to tilting of images, although the above shooting guiding procedure has provided guiding the user for different image fields, a desirable-quality stereo image still cannot be output. The system will capture image features in the function of adjusting and outputting stereo images, and use the image features to adjust two images with different view angles to a high quality state.

FIG. 6 is a schematic flowchart illustrating a method for adjusting stereo images according to an embodiment of the disclosure. Referring to FIG. 6, in Step S200, multiple original view-angle images, for example, output from FIG. 2, are taken. In Step S202, a set of feature points is obtained by analysis for the multiple view-angle images. In Step S212, a camera information respectively corresponding to the multiple view-angle images is obtained. In Step S204, the set of feature points is weighted according to the camera information and a shooting mode, for example, whether the shooting mode is a portrait or landscape shooting mode. In Step S206, one image is selected from the multiple view-angle images to serve as a reference view-angle image, and a rectification procedure of other view-angle images is performed, that is, the view-angle images to be corrected are rotated according to the set of weighted feature points to achieve rectification. In Step S208, an image translation step is performed, that is, a proper translation of the corrected view-angle images after rectification is effected according to coordinates of the set of weighted feature points, so as to adjust a parallax effect. Further, in Step S214, after the feature weighting processing is completed in Step S204, new feature point coordinates are obtained for use in translation in Step S208. In Step S210, at least two corrected view-angle images are output. That is to ay, at least a part of view-angle images are output from a set of view-angle images including the reference view-angle image and the corrected view-angle images according to a required number of view-angle images to be output by the camera.

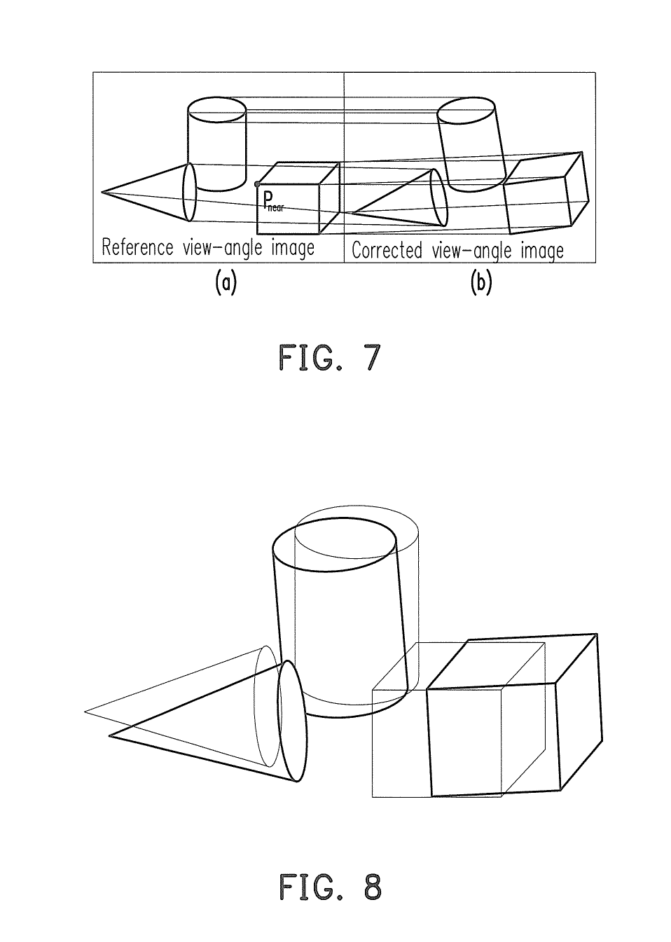

A further detailed description is given below. FIG. 7 is a schematic diagram illustrating a feature point capturing mechanism according to an embodiment of the disclosure. Capturing of feature points is mainly to capture corresponding coordinate locations of an object at the same location in space projected onto different image planes for the reference view-angle image and the corrected view-angle images with different view angles, and coordinate locations corresponding to features may be calculated for left and right images by using a feature point comparison algorithm method such as Speeded Up Robust Features (SURF) or Scale-invariant feature transform (SIFT).

In consideration of weighting, since the number of feature points may vary with different shooting contents, features must be uniformly distributed in each area of the image as possible, rather than being concentrated in a particular area. Moreover, in order to enhance the adjustment of a subject feature area in the shooting mode when nonlinear image adjustment is performed, the proportion of features in algorithm is increased for the area selected by the mode.

Then, for the rectification mechanism, since the location of the camera changes and moves during shooting, extrinsic parameters of the camera are changed, so that fundamental matrixes of the camera at different locations must be calculated. Since the same lens is utilized for shooting, the part involving intrinsic parameters may not be performed. After the left and right images are rectified using the fundamental matrixes, nonlinearly corrected left and right images may be obtained, and a subsequent image adjustment procedure can be performed.

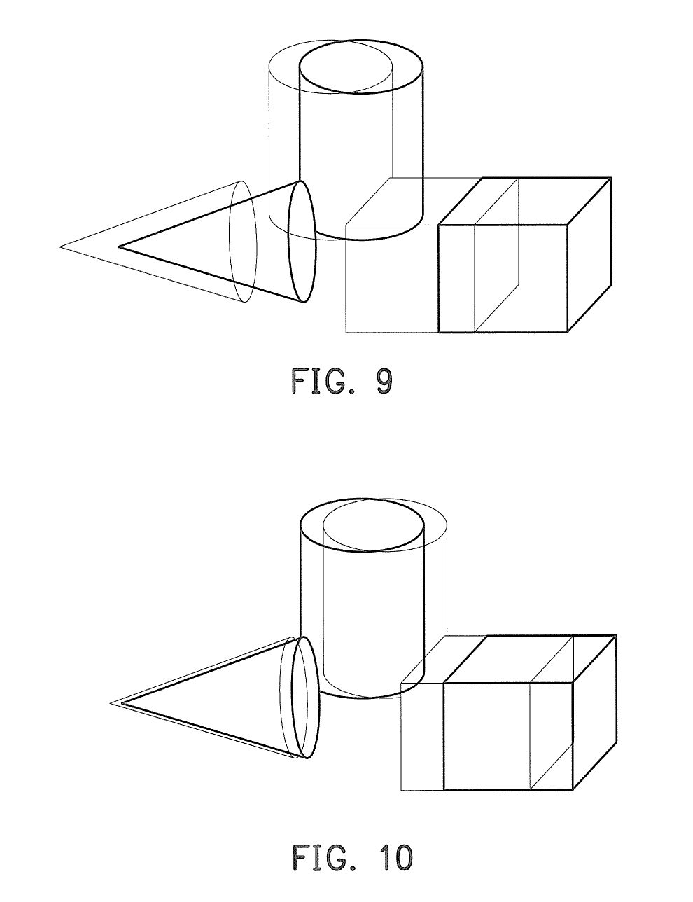

FIG. 8 is a schematic diagram illustrating two original 2D images before rectification according to an embodiment of the disclosure. FIG. 9 is a schematic diagram illustrating two 2D images after rectification according to an embodiment of the disclosure. Referring to FIG. 8, when two original 2D images before rectification are superposed, since the user does is not capable of perfect operation in motion, a rotational shift may occur between the two images. Referring to FIG. 9, for example, by using one image as a reference, the other image may be rotated by the rectification procedure such that the two images are at the same horizontal angle.

Then, parallax adjustment is described. After the left and right images are rectified, parallax adjustment may still be required. At this time, the image is adjusted through horizontal movement according to new coordinates of feature points after rectification together with the shooting information, and this method may reduce the parallax that may cause discomfort. A value of movement for horizontal adjustment of the image after rectification is provided according to the information recorded during shooting. An implementation is, for example: when the selected shooting mode is a portrait shooting mode, or a result of human face detection in the image shows that a human face exists in the image, automatic parallax adjustment of the left and right images is performed for coordinates of a feature point group at the location of the human face in the image, so as to minimize the sum of absolute values of parallaxes at the location of the human face. When the shooting mode is other shooting modes, feature point detection is performed for an area that is the lowermost quarter of the left and right images, and an average value of parallax P_{neg} is calculated as follows:

$${P}_{neg} = \frac{1}{i} {\sum }_{1}^{i} {Disparity}_{i} * ( \frac{{H}_{img} - {y}_{i}}{0.25 * {H}_{img}} ) , \qquad ( 5 )$$

where an exponent i is the total number of detected feature points, H_{img} is an image height, Disparityᵢ is a value of parallax of the i^{th} feature point, and yᵢ is an Y coordinate of the i^{th} feature point in the image. After the average value of parallax P_{neg} is calculated, the right image is displaced left by P_{neg} pixels, and the average value of parallax P_{neg} is 0 after adjustment.

It can be seen from the existence of a shift in the rectified data in FIG. 9 that, some secondary objects have too large amounts of parallax, causing discomfort when viewing 3D images. FIG. 10 is a schematic diagram illustrating two 2D images after parallax adjustment according to an embodiment of the disclosure. Referring to FIG. 10, two 2D images after parallax adjustment have a proper parallax.

The output format of stereo images may be a specification that can be accepted by ordinary display elements, and does not need to be particularly limited.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A camera system with guide for taking stereo images, comprising:
an imaging unit, capable of taking a view-angle image corresponding to a target image field at a location;
an information unit, respectively recording a shooting condition information of shooting the target image field at the location, and the view-angle image being taken;
a processing unit, receiving the shooting condition information and analyzing the shooting condition information to estimate a shooting condition of shooting the target image field by the imaging unit next time, until a predetermined number of the view-angle images are taken, wherein after the predetermined number of the view-angle images are completed, the processing unit performs a stereo image correction process on the view-angle images;
a guiding unit, for converting the shooting condition estimated by the processing unit into a guiding information to guide the imaging unit to move to the location; and
an image storage unit, for storing the view-angle images after the stereo image correction process.

2. The camera system with guide for taking stereo images according to claim 1, wherein the predetermined number of the view-angle images are respectively corresponding to different view angles, and any two of the view-angle images form a stereo visual image.

3. The camera system with guide for taking stereo images according to claim 1, wherein the shooting condition information comprises information of the location and a focal length of the imaging unit.

4. The camera system with guide for taking stereo images according to claim 1, further comprising a display unit, wherein the guiding information of the guiding unit is displayed by the display unit to guide the user.

5. An image-shooting method with guide for taking stereo image, used in a camera system, wherein the camera system utilizes a same lens to take images, the method comprising:
selecting a shooting mode;
providing a guiding information by a display unit;
taking a set of images for a target image field by moving the lens to multiple guiding locations according to the guiding information, wherein the set of images is at least two view-angle images with different view angles;
correcting the at least two view-angle images with a stereo visual effect; and
outputting the at least two view-angle images being corrected, and outputting a corresponding shooting information.

6. The image-shooting method with guide for taking stereo image according to claim 5, further comprising providing the guiding information and outputting the corrected at least two view-angle images by an image processing algorithm module in a processing circuit unit of the camera system.

7. The image-shooting method with guide for taking stereo image according to claim 6, wherein different guiding information are provided according to different shooting modes to guide the lens to take images at an expected location.

8. The image-shooting method with guide for taking stereo image according to claim 6, wherein the processing circuit unit obtains by analysis multiple feature points of the at least two view-angle images at the same time.

9. The image-shooting method with guide for taking stereo image according to claim 6, wherein the provided guiding information is an expected location provided through estimation according to a camera information corresponding to a reference image in the set of images.

10. The image-shooting method with guide for taking stereo image according to claim 6, wherein the step of correcting the at least two view-angle images comprises:
determining a set of feature point information;
rectifying a corrected view-angle image to be corrected by using a reference view-angle image as a reference according to the set of feature point information; and
translating the corrected view-angle image.

11. A method for adjusting stereo images, used in a camera, the method comprising:
taking at least a first view-angle image and a second view-angle image;
analyzing out a set of feature points from the first view-angle image and the second view-angle image, respectively;
obtaining a camera information respectively corresponding to the first view-angle image and the second view-angle image;
weighting the set of feature points according to the camera information;
performing an image rectification procedure, by rotating at least one of the first view-angle image and the second view-angle image according to the set of weighted feature points to achieve rectification;
performing an image translation step, by a proper translation of the first view-angle image and the second view-angle image after rectification according to coordinates of the set of weighted feature points, so as to adjust a parallax effect; and
outputting an adjusted first view-angle image and an adjusted second view-angle image.

12. The method for adjusting stereo images according to claim 11, wherein the first view-angle image and the second view-angle image taken are from photos or videos.

13. The method for adjusting stereo images according to claim 11, wherein a feature calculating method for obtaining by analysis the set of feature points is a feature matching algorithm.

14. The method for adjusting stereo images according to claim 11, wherein the camera information makes reference to a focusing location information provided by the camera.

15. The method for adjusting stereo images according to claim 11, wherein the image rectification procedure comprises determining a difference before and after rectification, so as to determine whether the first view-angle image and the second view-angle image are correctly rectified.

16. A camera system with guide for taking stereo images, comprising:
a lens, comprising a single optical axis;
an optical image sensor, for recording at least two view-angle images taken by the lens, at least comprising a first image and a second image;
a memory unit, for recording the first image and the second image obtained by the optical image sensor, and a camera information during shooting; and
a processing circuit unit, connected to the memory unit, wherein the processing circuit unit comprises an image processing algorithm module, for calculating a guiding information to guide the lens to move to an expected location according to the first image to take the second image.

17. The camera system with guide for taking stereo images according to claim 16, further comprising a display unit, for displaying the guiding information.

18. The camera system with guide for taking stereo images according to claim 16, wherein the processing circuit unit further comprises a correction process, for correcting the view-angle images, and the correction process comprises:
selecting one of the view-angle images as a reference view-angle image, and selecting each of the other view-angle images as a corrected view-angle image to be corrected;
determining by analysis a feature point group of the view-angle images;
calculating a correction parameter for each of the selected corrected view-angle images to be corrected relative to the reference view-angle image so as to correct a location of the feature point group; and
outputting at least a part of the reference view-angle image and the corrected view-angle image according to a number of view-angle images to be output.
